(19) United States
(12) Patent Application Publication
(10) Pub. No.: US 2007/0277112 A1
(43) Pub. Date: Nov. 29, 2007

(54) Three-Dimensional User Interface For Controlling A Virtual Reality Graphics System By Function Selection

(75) Inventors: Andreas Rossler, Stuttgart (DE); Ralf Breining, Ostfildern (DE); Jan Wurster, Stuttgart (DE)

Correspondence Address: BROOKS KUSHMAN P.C., 1000 TOWN CENTER, TWENTY-SECOND FLOOR, SOUTHFIELD, MI, 48075, US

(73) Assignee: ICIDO GESELLSCHAFT FUR INNOVATIVE INFORMATIONSSYST, Stuttgart (DE)

(21) Appl. No.: 10/595,183

(22) PCT Filed: Sep. 16, 2004
(86) PCT No.: PCT/DE04/02078

§ 371 Date: Oct. 24, 2006

(30) Foreign Application Priority Data
Sep. 19, 2003 (DE) 103 43 967.6

(51) Int. Cl. G06F 3/00

(52) U.S. Cl. 715/764

(57) ABSTRACT

The invention relates to a graphical user interface for controlling a virtual reality (VR) graphics system by means of interactions with a function selection that provides at least two functions, whereby the VR graphics system has a projection device for visualizing a virtual three-dimensional scene, and interactions with the VR graphics system ensue by using at least one interaction unit. Said interaction unit, while interacting with a sensor system for detecting a respective physical-spatial position and/or orientation of the interaction unit, serves to generate and transfer position data inside and/or to the VR graphics system. The inventive graphical user interface comprises, in particular, an interaction element, which is functionally and visually formed from at least two partial elements that each provide a mentioned function selection. These at least two partial elements are provided so that they can move relative to one another in a virtual-spatial manner by means of physical-spatial movement of the interaction unit, and a function selection ensues by means of the ensuing virtual-spatial movement of the at least two partial elements relative to one another.

The present invention generally relates to graphics systems for virtual reality (VR) applications and specifically relates to a graphical user interface for controlling such a VR graphics system by means of interactions with a function selection system that provides at least two functions and to a corresponding VR graphics system as claimed in the preambles of the respective independent claims.

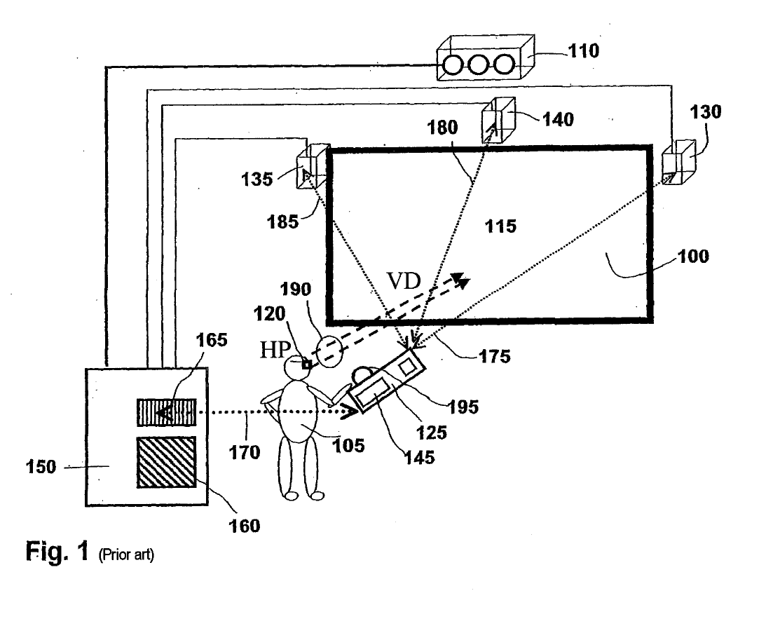

A VR graphics system which is concerned in this case is evident from DE 101 25 075 A1, for example, and is used to generate and display a multiplicity of three-dimensional views which together represent a so-called “scene”. In this case, such a scene is usually correspondingly visualized using the method (which is known per se) of stereoscopic projection onto a screen or the like. So-called immersive VR systems which form an intuitive man-machine (user) interface for the various areas of use (FIG. 1) are widespread. Said graphics systems use a computer system to highly integrate the user into the visual simulation. This submersion of the user is referred to as “immersion” or an “immersive environment”.

As a result of the fact that three-dimensional data or objects are displayed to scale and as a result of the likewise three-dimensional ability to interact, these data or objects can be assessed and experienced far better than is possible with standard visualization and interaction techniques, for example with a 2D monitor and a correspondingly two-dimensional graphical user interface. A large number of physical real models and prototypes may thus be replaced with virtual prototypes in product development. A similar situation applies to planning tasks in the field of architecture, for example. Function prototypes may also be evaluated in a considerably more realistic manner in immersive environments than is possible with the standard methods.

Such a visual VR simulation is controlled in a computer-aided manner using suitable input units (referred to below, for the purpose of generalization, as “interaction units” since their function clearly goes beyond pure data input) which interact with a user interface that can be temporarily inserted into the VR simulation. In addition to pushbuttons, the interaction units have a position sensor which interacts, via a cable or radio connection, with a position detection sensor system (which is provided in the VR graphics system) and can be used to continuously measure the spatial position and orientation of the interaction unit in order to carry out the interactions with the user interface on the basis of the physical movement, position and orientation of the interaction unit in the space.

A corresponding graphical user interface is disclosed, for example, in DE 101 32 243 A1. The handheld cableless interaction unit described there is used for generating and transmitting the location, position and/or movement data (i.e. spatial position coordinates of the interaction unit) provided by a position sensor (already mentioned) and thus, in particular, for virtual three-dimensional navigation in an existing scene. Said position data comprise the six possible degrees of freedom of translation and rotation of the interaction unit and are evaluated in real time in a computer-aided manner in order to determine a movement or spatial trajectory of the interaction unit.

The graphical user interface described in DE 101 32 243 A1 comprises, in particular, a menu system which is likewise visualized in a three-dimensional (stereoscopic) manner, for example a spherical menu which can be controlled using translational and/or rotational movements of the interaction unit. In this case, functions or menu items are selected, for example, by means of a rotational movement (which is carried out by the user) of the interaction unit.

In the case of these user interfaces, it is desirable for the operation of said interactions for operating and controlling a function selection or menu system (which is concerned in this case) to be configured in an even simpler and more intuitive manner, particularly in the case of more complex function selection operations. At the same time, however, the highest possible degree of operational reliability and operating safety is also intended to be ensured.

The inventive graphical user interface for controlling a virtual reality (VR) graphics system (which is concerned in this case) by means of said interactions comprises a visual interaction element which functionally and visually comprises at least two subelements which interact with one another, each of these subelements providing a function selection having at least two respective functions. This at least two-part interaction element is preferably implemented in the form of a virtual three-dimensional menu system or function selection system.

In particular, the at least two subelements are designed such that they can be moved in a virtual three-dimensional manner relative to one another by means of a physical three-dimensional movement of the interaction unit, said function or menu being selected by means of the at least two subelements being moved relative to one another.

In one preferred refinement, at least the first subelement of the visual interaction element that is inserted into the scene at least temporarily is displayed at an at least temporarily fixed position within the scene, at least the second subelement being able to be moved both functionally and visually in a virtual three-dimensional manner by means of a physical three-dimensional movement of the interaction unit relative to the first subelement—similar to the known “notch and bead sights” principle—in order to trigger a function by means of this relative movement between the at least two subelements.

According to another refinement, this relative movement is effected, in the case of a translational displacement, in such a manner that the at least two subelements at least partially touch or overlap, which is likewise visualized in the scene, as a result of which said function or menu selection and thus, overall, operation and control of the user interface appear to be very intuitive and thus also user-friendly.

In one particularly advantageous refinement, the proposed visual interaction element comprises three subelements, to be precise, in the case of a spherical menu, an inner sphere which is formed in one part, a spherical shell which is formed from at least two spherical shell segments and is arranged on the surface of the inner sphere and a ring which is arranged in the outer region of the sphere or spherical shell and comprises at least two ring segments. In this refinement, the inner sphere is used to represent an item of state information relating to the instantaneous state of the entire spherical menu, for example the instantaneous position in a menu tree. That is to say said state information indicates, for example, whether the menu items which are represented by the spherical shell segments are a main menu or, for instance, a submenu that is hierarchically subordinate to the main menu. A function which is to be triggered using the outer ring is preferably activated, in this refinement, by means of the inner sphere making contact with, or overlapping, one of the at least two ring segments.

When operating such a spherical menu, the spherical shell segments can be correspondingly rotated about the inner sphere, by means of user-guided rotation of the interaction unit, in order to make it possible for different spherical shell segments to overlap the available ring segments, for example. In order to further simplify such control, another refinement provides an angle-dependent (for example in 30° steps) latching function which depends on the angle of rotation of the interaction unit, with the result that the spherical shell segments and the ring segments are always clearly opposite one another and ambiguous interactions between these segments are therefore virtually excluded.

In order to further increase the operating comfort, provision may additionally be made for a further relative displacement to be actively prevented as of a prescribable degree of partial overlap/touching between the inner sphere and the ring. In addition to said rotation-dependent latching function, this also enables latching, which takes place in the event of translational movements of the inner sphere, along the possible displacement path of the sphere.

In order to render said translational movements of the inner sphere relative to the ring more intuitive and thus more user-friendly, the sphere element is displaced relative to the ring element, in a further refinement, as if the inner sphere were connected to the individual ring segments via imaginary elastic bands or the like. This likewise ensures, in the manner of a latching function, that the translation of the inner sphere is also always led or is even forced to lead to a particular ring segment, and an adjacent ring element, for instance, cannot be driven inadvertently.

The actions or functions which are triggered according to the invention by rotational and translational movements may be controlled and evaluated using empirically prescribable threshold values in such a manner that a physical three-dimensional translational or rotational movement (which is carried out by the user) of the interaction unit triggers a corresponding action or function only when the magnitude of the movement exceeds the respective threshold value. This makes it possible to more effectively prevent incorrect operation, for example an account of physical movements of the interaction unit which are effected inadvertently.

The inventive user interface may also be visually displayed in animated form in such a manner that, when the respective movable subelement (for example the above-described inner sphere) is moved or in the event of the at least two subelements (for example the above-described inner sphere and the outer ring) touching/overlapping, a change in the form or shape of at least one of these subelements occurs.

Said functional sequences of the proposed user interface may also be assisted by means of at least one control element (pushbutton or the like) which is arranged on the interaction unit. By way of example, such a control element may be used to trigger not only the insertion of the visual interaction element into the respective scene but also other functions, for example activation of the abovementioned touching/overlapping function etc. It goes without saying that, as an alternative to such a control element, the voice and/or gestures/facial expressions of the user may also be evaluated in a manner known per se. The abovementioned functions may thus be implemented, for example, by means of simple voice commands, for example, “open menu system”, “activate overlapping function” or the like.

In another particularly advantageous refinement, provision may be made for said touching/overlapping function to additionally comprise logic (boolean) operations, i.e. when a subelement touches or overlaps a particular second subelement of the inventive user interface, a particular logic operation is carried out, a function, menu selection or the like, which is formed only by the respective logic combination, being carried out. This makes it possible for the inventive user interface to also be adapted to very complex functional sequences.

As a result, the inventive graphical user interface thus affords the advantage that even complex interactions, for example over a plurality of function or menu levels, can be effected very intuitively, to be precise solely by means of said movement modes (in the six possible degrees of freedom as regards translation and rotation) of the interaction unit. Said overlapping/touching function makes it possible, in particular, to rapidly and reliably change over between, for example, different subfunctions or submenus of a function selection or of a menu system.

In comparison with the prior art mentioned at the outset, the inventive user interface is therefore easier to handle and at the same time has a very high level of operational reliability as regards possible operating faults caused by a user. Overall, virtual three-dimensional navigation is therefore considerably simplified as a result of different function/menu levels which are inserted into the scene, to be precise even without the use of a pointer which is frequently used in the prior art and is displayed in animated form.

The invention can be used, with said advantages, both in VR graphics systems having cableless interaction units and in those having cable-bound interaction units which are preferably hand-guided by the user. As already stated, in addition to said use of a pushbutton that is arranged on the interaction unit, the possible user interactions may generally also be assisted in this case by acoustic or optical interactions, for example voice, gestures or the like.

In addition, it goes without saying that, in the case of the user interface proposed, it is not important which of the two subelements is moved (i.e. translated or rotated) relative to which subelement and which of the subelements is respectively fixed and which is respectively movable in the preferred refinement.

Instead of an above-described spherical menu, the invention may also be used with said advantages in a menu system which is of completely different graphical design if the menu system has at least two parts in the manner mentioned. Use in three-dimensional planar text menu systems or the like is thus also suitable, for example. It also goes without saying that an above-described spherical menu system may also be formed from ellipsoidal or even polygonal three-dimensional forms.

The inventive virtual three-dimensional user interface is described in greater detail below with reference to exemplary embodiments which are illustrated in the drawing and which reveal further features and advantages of the invention. In said exemplary embodiments, identical or functionally identical features are referenced using corresponding reference symbols.

In the drawing:

FIG. 1 shows a simplified overview of an immersive VR (virtual reality) graphics system (which is concerned in this case) according to the prior art;

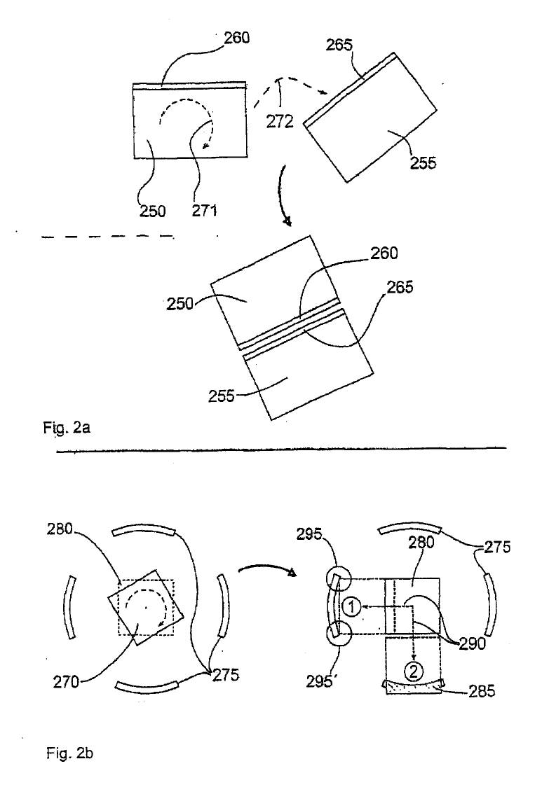

FIGS. 2a,b show two diagrammatically illustrated exemplary embodiments of the inventive virtual three-dimensional user interface;

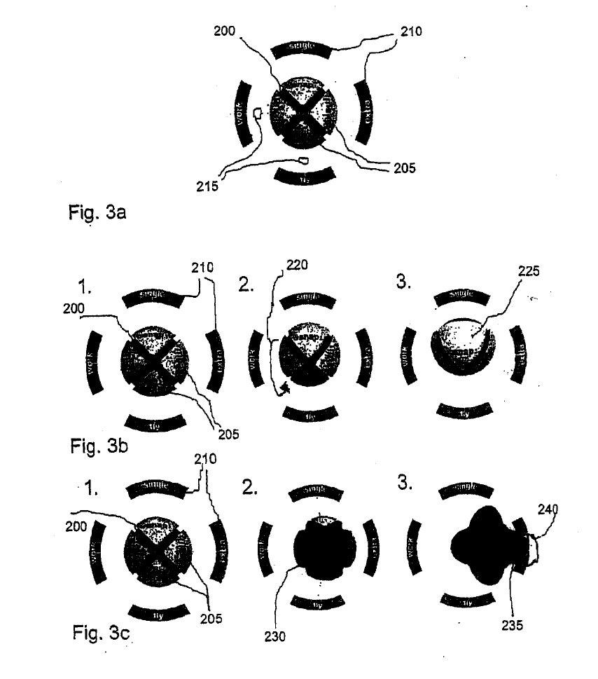

FIGS. 3a-c show a perspective view of a preferred exemplary embodiment of the inventive user interface (in this case: spherical menu) for use in a VR graphics system (FIG. 2a) shown in FIG. 1 and two typical interaction sequences (FIGS. 3b and 3c) using the user interface shown in FIG. 3a;

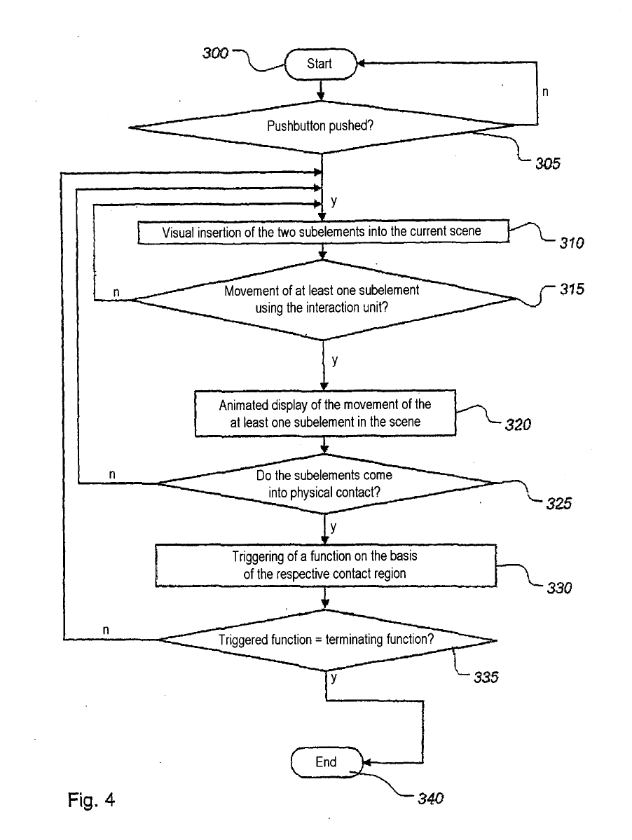

FIG.4 uses a flowchart to show a typical functional sequence when controlling an inventive user interface; and

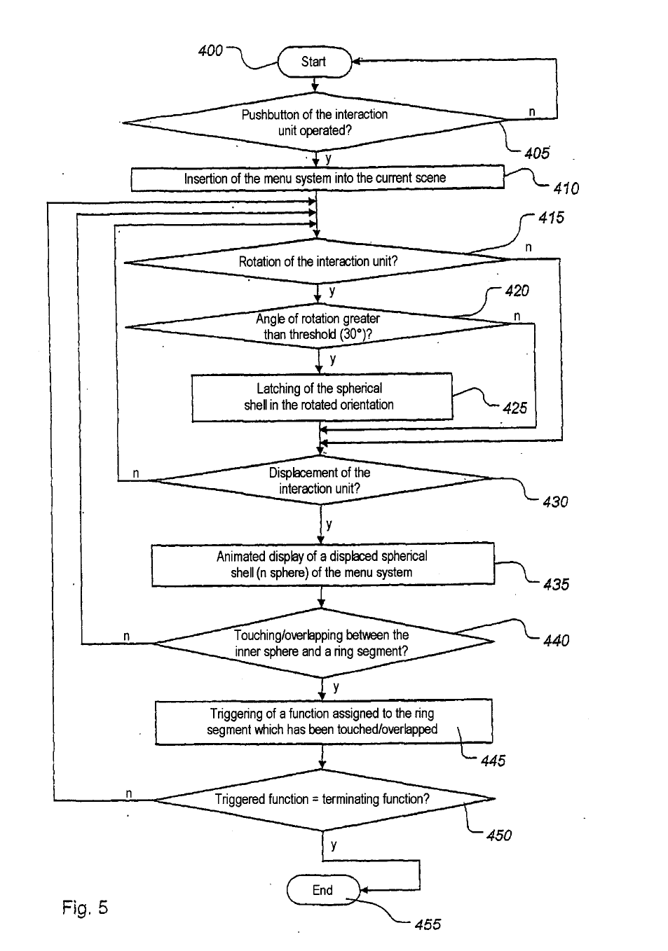

FIG. 5 shows a functional sequence, which is more detailed in comparison with FIG. 4, in the user interface shown in FIGS. 3a-3c.

The VR graphics system which is diagrammatically illustrated in FIG. 1 has a projection screen 100 in front of which a person (user) 105 stands in order to view the scene 115, which is generated there via a projector 110, using stereoscopic glasses 120. It goes without saying that auto-stereoscopic screens or the like may also be used in the present case instead of the stereoscopic glasses 120. In addition, the projection screen 100, the projector 110 and the glasses 120 may be replaced in the present case with a data helmet which is known per se and then comprises all three functions.

The user 105 holds an interaction unit 125 in his hand in order to generate preferably absolute position data such as the spatial position and orientation of the interaction unit in the physical space and to transmit said data to a position detection sensor system 130-140. Alternatively, however, relative or differential position data may also be used but this is not important in the present context.

The interaction unit 125 comprises a position detection system 145, preferably an arrangement of optical measurement systems 145, both the absolute values of the three possible angles of rotation and the absolute values of the translational movements of the interaction unit 125, which are possible in the three spatial directions, being detected using said arrangement of measurement systems and being processed in real time by a digital computer 150 in the manner described below. Alternatively, these position data may be detected using acceleration sensors, gyroscopes or the like which then generally provide only relative or differential position data. Since this sensor system is not important in the present case, a more detailed description is dispensed with here and reference is made to the documents mentioned at the outset.

Said absolute position data are generated by a computer system which is connected to the interaction unit 125. To this end, they are transmitted to a microprocessor 160 of a digital computer 150 in which, inter alia, the necessary graphical evaluation processes (which are to be assumed to be familiar to a person skilled in the art) are carried out in order to generate the stereoscopic three-dimensional scene 115. The three-dimensional scene representation 115 is used, in particular, for visualizing object manipulations, for three-dimensional navigation in the entire scene and for displaying function selection structures and/or menu structures.

In the present exemplary embodiment, the interaction unit 125 is connected, for carrying data, to the digital computer 150, via a radio connection 170, using a reception part 165 (which is arranged there). The position data which are transmitted from the sensors 145 to the position detection sensor system 130-140 are likewise transmitted in a wireless manner by radio links 175-185.

Additionally depicted are the head position (HP) of the user 105 and his viewing direction (VD) 190 with respect to the projection screen 100 and the scene 115 projected there. These two variables are important for calculating a current stereoscopic projection insofar as they considerably concomitantly determine the necessary scene perspective since the perspective also depends, in a manner known per se, on these two variables.

In the present exemplary embodiment, the interaction unit 125 comprises a pushbutton 195 which the user 105 can use, in addition to said possibilities for moving the interaction unit 125 in the space, to trigger a particular interaction, as described below with reference to FIG. 3. It goes without saying that two or more pushbuttons may also alternatively be arranged in order to enable further different interactions, if appropriate. Instead of one or more pushbuttons, corresponding user inputs may also be effected, as already mentioned, using voice, gestures or the like. Additionally depicted in FIG. 1 are the head position (HP) of the user 105 and his viewing direction (VD) 190 with respect to the projection screen 100 and the scene 115 projected there. These two variables are important for calculating a current stereoscopic projection insofar as they considerably concomitantly determine the necessary scene perspective in a manner known per se.

The central element of the immersive VR graphics system shown is the stereoscopic representation (which is guided (tracked) using the position detection sensor system 130-140) of the respective three-dimensional scene data 115. In this case, the perspective of the scene representation depends on the observer's vantage point and on the head position (HP) and viewing direction (VD). To this end, the head position (HP) is continuously measured using a three-dimensional position measurement system (not illustrated here) and the geometry of the view volumes for both eyes is adapted according to these position values. This position measurement system comprises a similar sensor system to said position detection system 130-140 and may be integrated in the latter, if appropriate. A separate image from the respective perspective is calculated for each eye. The difference (disparity) gives rise to the stereoscopic perception of depth.

In the present case, an interaction by a user is understood as meaning any action by the user, preferably using said interaction unit 125. Included in this case are the movement of the interaction unit 125 as shown in FIGS. 2a, 2b and 3a-3c and the operation of one or more pushbuttons 195 which are arranged on the interaction unit 125. Acoustic actions by the user, for example a voice input, or an action determined by gestures may additionally be included.

FIGS. 2a and 2b show two exemplary embodiments (which are illustrated only diagrammatically in this case) of the inventive virtual three-dimensional user interface, said exemplary embodiments being intended to be used to explain only the fundamental method of operation of the inventive user interface.

In the exemplary embodiment shown in FIG. 2a, provision is made of two subelements 250 and 255 which are approximately square. It goes without saying that this diagrammatically highly simplified illustration may be used only to illustrate the fundamental technical concepts and, in the present field of use of the VR graphics systems, these subelements will likewise be preferably three-dimensional, for example in the form of three-dimensional cubes, cuboids, spheres or the like. In the present example, each of the two subelements 250, 255 has four action elements, to be precise the respective outer sides of the two squares, which are available for interactions by a user, in particular. Two of these outer sides 260, 265 are respectively emphasized in this illustration using a double line. The dashed arrows 271 and 272 are intended to indicate that, in the interaction shown here, the subelement 250 is rotated 271 and displaced 272 in such a manner that the outer side 260 comes to rest on the outer side 265. This second interaction phase is illustrated in the lower half of FIG. 2a.

Combining the two subelements 250, 255 on the two outer sides 260, 265 now triggers an action or function which will be described in even more detail below. The action or function is triggered, in particular, when the outer sides 260, 265 have reached a particular degree of convergence or only when they have come into contact virtually (i.e. in the current VR scene). It goes without saying that further actions or functions may also be triggered by the other possible interactions between the remaining outer sides of the subelements 250, 255.

In the exemplary embodiment shown in FIG. 2b, one subelement is again square 270, whereas the second subelement is formed by a ring 275 which is arranged concentrically around the square subelement 270 in the initial position of the latter. In the present example, the ring 275 is subdivided into four segments 275, each of these segments 275 being assigned to a separate action or function.

In this exemplary embodiment, interactions are carried out by the square subelement 270 first of all being rotated into a new position (i.e. spatial orientation) 280. The subelement 270 is then displaced, by means of a translational movement that corresponds to the two movement paths 290 which are shown only by way of example here, either into the position designated ‘1’ (in the round circle) or into the position which is correspondingly designated ‘2’. In the example of ‘1’, the square subelement 270, 280 comes into (virtual) contact, at the respective corners 295, 295′, with the ring segment shown, as a result of which an action or function is triggered. In the other case of ‘2’, the action or function is triggered only when there is an overlap 285 (shown) between the two subelements 270, 275.

It should be noted that, in an alternative refinement, the two subelements shown may also both be moved, for example toward one another. That is to say it is only the relative movement (shown) between the two subelements which is important in the present case. The two subelements may also even be controlled by a user with both hands, the user then holding a separate above-described interaction unit in each hand.

FIG. 3a shows, in a perspective illustration, a view of a preferred exemplary embodiment of the inventive user interface, to be precise using the example of a spherical menu system (which was already described at the outset) in the present case. FIGS. 3b and 3c which are described below show two typical interaction sequences for this spherical menu system.

In the exemplary embodiment, it shall be assumed that the interaction unit has two buttons 195 (FIG. 1) which can preferably be operated using the user's thumb and index finger. These two buttons may be used in two ways, to be precise by briefly pushing them (clicking) and by holding them down (holding) for a relatively long time. These two actions result in a total of four possible interactions, i.e. in the present exemplary embodiment: clicking using the thumb=termination, clicking using the index finger=action, holding using the thumb=gripping and holding using the index finger=menu. A graphical menu system is thus gripped by holding the button assigned to the thumb and the menu is held by holding down the thumb button. Menu systems which have already been inserted into the scene may be activated by pushing and holding down the index finger button. A function is left or terminated by clicking the thumb button.

As can be seen from FIG. 3a, the present spherical menu system has three parts and comprises an inner menu sphere 200 which provides a status indication (already mentioned) for indicating the instantaneous state of the menu system as regards the menu hierarchy. The inner menu sphere 200 is surrounded by a spherical shell 205 which has four parts in the present case and, by means of rotation, can be used to activate different menu entries in the main menu (“main”), to be precise the entries “group”, “snap”, “state” and “meas” in the present case. A further four menu entries “work”, “single”, “fly” and “extra” are situated in four corresponding segments 210 of an outer menu ring.

The main menu (“main”) of the spherical menu system 200-210, which has three parts in the present case, therefore contains eight different menu entries, four of which can be reached by rotating the interaction unit 125 (not shown here) and four of which can be reached by translating (displacing) the interaction unit 125.

When the interaction unit 125 is physically rotated in a three-dimensional manner on account of a corresponding hand movement by the user, the inner menu sphere 200 rotates in a corresponding manner. As of an angle of rotation of 60° in the present case, the inner menu sphere 200 latches with an orientation which has been displaced through 90° relative to the previous orientation, i.e. the “play” of the latching function is 30° in the present case. In the example, this latching is activated by releasing one of the two buttons of the interaction unit 125.

Displacing (translating) the inner sphere 200 along one of four possible translation paths, which are prescribed using “elastic-band-like” guides 215, makes it possible for the inner sphere 200 to be moved to the four menu entries 210 which are arranged in the form of a ring. The function corresponding to the respective menu entry 210 is activated when the inner sphere 200 touches or overlaps (FIG. 2c) the respective ring segment 210. This makes it possible to rapidly change over between different menus or submenus.

FIGS. 3b and 3c now illustrate typical interaction sequences, which are respectively designated using sequences of digits 1.-3., when a function is selected by rotating the spherical shell 205 and displacing the spherical shell 205 in a translational manner.

In the case of a pure rotation (FIG. 3b), one of the two buttons 195 of the interaction unit 125, which are present in this case, is first of all pushed and is then held down, as a result of which the menu system is first of all inserted into the current scene. The interaction unit 125 is then physically rotated by the user. As of a threshold value for the physical rotation of the interaction unit (30° in the present example), the inner sphere 200 also begins to rotate in a corresponding manner. Releasing the button 195 causes the inner sphere 200 and the spherical shell 205 to latch at the respective nearest latching point in the 30° gradation, the latching function “snap” thus being selected in the present example.

In the case of a pure displacement (FIG. 3c), the button 195 is again pushed and held down, as a result of which the menu system first of all appears in the scene. Physically moving the interaction unit 125 in a translational manner causes the inner sphere 200, together with the spherical shell 205, to be displaced until it comes to touch or overlap one of the ring segments 210. As soon as this touching occurs, a new menu or submenu appears or a prescribed function selection takes place. Even the translational movement results in the change in shape (shown) of the spherical shell. The spherical shell 205 may also be animated in a corresponding manner in the case of the sphere or spherical shell touching or overlapping the respective ring segment 210 affected.

The present exemplary embodiment also provides that, as of a particular prescribable partial overlap or partial touching between the spherical shell 205 or the sphere 200 and the respective ring segment 210 affected, a further relative displacement between these two subelements is suppressed, which approximately corresponds to translation-related latching.

One variant may provide for the overlapping-dependent interaction which is shown in FIGS. 2b and 3c to be activated, when a menu entry associated with the spherical shell 205 and a menu entry associated with the ring 210 overlap (FIG. 3c), in such a manner that the menu entries which are combined in the process simultaneously carry out a logic (boolean) combination. Provision may thus be made, for instance, for the “snap” function shown in FIG. 3b to activate either a combined “single-snap” or “extra-snap” function when it touches or overlaps one of the ring segments 210. It goes without saying that other types of combination such as ‘OR’ or ‘NOT’ may also be provided instead of such an ‘AND’ combination.

FIG. 4 now uses a flowchart to show a typical functional sequence when controlling the inventive user interface. After the start 300 of the routine, a check is first of all carried out 305 in a loop in order to determine whether a particular pushbutton of the interaction unit 125 has been operated. If this is the case, the two subelements 250, 255 and 270, 275 shown in FIGS. 2a and 2b are inserted into the current VR scene 310. Otherwise, step 305 is carried out again, if appropriate after a certain delay, in accordance with said loop.

A check is then carried out in step 315 in order to determine whether a virtual movement (which is caused by physical movement of the interaction unit) of at least one of the two subelements 250, 255, 270, 275 has been effected in the scene. If no movement at all of either of the two subelements has been determined, the process jumps back to step 310. Otherwise, in accordance with such a movement, the respective subelement is preferably displayed in animated form in the scene 320 in order to also visually indicate the movement (rotation or translation). A check is carried out in the following step 325 in order to determine whether the two subelements 250, 255, 270, 275 have come into physical contact (or spatial proximity) during the movement. If this is not the case, the process jumps back to step 310 in order to carry out the steps which have just been described again. Otherwise, a particular action or function is triggered 330 on the basis of the respective contact region or the respective ring segments 275 involved. Finally, a check is carried out in step 335 in order to determine whether the function triggered in step 330 is a function that terminates the entire procedure. Alternatively, a check can be carried out in this case in order to determine whether said pushbutton was operated again for said purpose of terminating the procedure. If this is the case, the procedure is terminated in step 340. Otherwise, the process jumps back to step 310 in order to carry out the above-described steps again.

FIG. 5 finally shows a typical functional sequence of the exemplary embodiment (illustrated in FIGS. 3a-3c) of the inventive user interface. After the start 400 of the routine shown, a check is first of all carried out 405 in the form of a loop in order to determine whether a (particular, if appropriate) pushbutton 195 of the interaction unit 125 (said thumb button in the present case) has been operated by the user. If it is determined that the pushbutton has been operated, the loop is left and the above-described spherical menu system 200-210 is inserted in the present case into the scene in the next step 410. A check is then carried out 415 in order to determine whether the interaction unit 125 has undergone user-guided rotation. If this condition 415 applies, a check is then also carried out 420 in order to determine whether, a prescribable threshold value for the rotation (30° in the present case) was exceeded during the user-guided rotation of the interaction unit 125. If this condition 420 has also been satisfied, the spherical shell is latched 425, both functionally and in visualized form, into the respective new angular orientation.

If no rotational movement of the interaction unit was detected 415 or if, in the case of detected rotation, said threshold value was not exceeded 420, the process changes to step 430 in which a check is also carried out in order to determine whether the interaction unit 125 has been displaced (in a translational manner). If this condition 430 applies, a sphere 200 or spherical shell 205 which has been correspondingly displaced is animated 435 in the scene, for example in the manner shown in FIG. 2c. A check is then carried out 440 in order to determine whether the inner menu sphere 200 has touched or overlapped one of the outer ring segments 210. If this is the case, a function or menu selection assigned to the overlapped ring segment 210 is activated or triggered in step 445.

However, if the condition 430 has not been satisfied or if, in the event of this condition 430 having been satisfied, the condition 440 has not been satisfied, the process jumps to step 450 in which a check is carried out in order to determine whether the function triggered in step 445 is a function that terminates the entire procedure with a view to removing the spherical menu system from the current scene again. Alternatively, a check may be carried out in this case in order to determine whether the pushbutton has been operated again or the like. If this condition 450 finally applies, the routine is terminated 455 or the process jumps back to step 415 in order to detect an interaction again in the manner described above.

1. A graphical user interface for controlling a virtual reality (VR) graphics system by means of interactions with a function selection system that provides at least two functions, the VR graphics system having a projection device for visualizing a virtual three-dimensional scene and the interactions with the VR graphics system being effected using at least one interaction unit which, in interaction with a position detection sensor system for detecting a respective physical spatial position and/or orientation of the interaction unit, is used to provide position data in the VR graphics system, characterized by an interaction element which is functionally and visually formed from at least two subelements which respectively provide said function selection, the at least two subelements being designed such that they can be moved in a virtual three-dimensional manner relative to one another by means of a physical three-dimensional movement of the interaction unit, and said function being selected by means of the at least two subelements being moved in a virtual three-dimensional manner relative to one another.

2. The user interface as claimed in claim 1, characterized in that at least one of the subelements is at least occasionally displayed at an essentially fixed position in the virtual scene, said function being selected by means of a virtual three-dimensional movement of the respective other subelement relative to the subelement which is at least occasionally displayed at the fixed position.

3-16. (canceled)

17. The user interface as claimed in claim 1, characterized in that the function selection is triggered, during the movement of the at least two subelements relative to one another, if the at least two subelements at least partially touch or overlap.

18. The user interface as claimed in claim 1, characterized in that the at least two-part interaction element is implemented in the form of a menu system, a function selection system or the like.

19. The user interface as claimed in claim 18, characterized in that the interaction element is formed by a spherical menu system which comprises three visual subelements and comprises an inner sphere which is formed in one part, a spherical shell which is formed from at least two spherical shell segments and is arranged on the visual surface of the inner sphere and a ring which is arranged in the outer region of the sphere or spherical shell and comprises at least two ring segments, the inner sphere providing to represent an item of state information relating to the instantaneous state of the spherical menu system.

20. The user interface as claimed in claim 19, characterized in that the state information indicates the menu level which is currently activated in the spherical shell segments in accordance with a menu tree.

21. The user interface as claimed in claim 19, characterized in that the spherical shell segments can be correspondingly rotated about the inner sphere, by means of user-guided rotation of the interaction unit, in order to make it possible to activate various spherical shell segments.

22. The user interface as claimed in claim 1, characterized in that provision is made of a latching function which depends on the angle of rotation of the interaction unit and/or of the respective subelement.

23. The user interface as claimed in claim 1, characterized in that an interaction which is to be effected on the basis of a physical rotational movement and/or physical translational movement of the interaction unit is triggered a corresponding interaction only when an empirically prescribable threshold value is exceeded.

24. The user interface as claimed in claim 17, characterized in that a further functional and/or visual relative displacement between the subelements is prevented as of a prescribable degree of overlap or touching between the at least two subelements.

25. The user interface as claimed in claim 1, characterized in that the relative displacement between the at least two subelements is effected in a guided manner.

26. The user interface as claimed in claim 1, characterized in that at least one of the subelements is visually displayed in animated form in the scene in the event of rotation and/or translation and/or touching.

27. The user interface as claimed in claim 1, characterized in that the interaction unit has at least one control element which is used to at least assist said functional sequences of the user interface.

28. The user interface as claimed in claim 1, characterized in that said functional sequences of the user interface are assisted using voice input and/or the detection of gestures or facial expressions of the user.

29. The user interface as claimed in claim 1, characterized in that said touching or overlapping function comprises at least one logic operation.

30. A virtual reality (VR) graphics system having a graphical user interface as claimed in claim 1.
